(19) United States
(12) Patent Application Publication
(10) Pub. No.: US 2020/0085130 A1
(43) Pub. Date: Mar. 19, 2020

(54) Baseball Helmet and Related Methods

(71) Applicant: Steven Benjamin Beckman, Boulder, CO (US)

(72) Inventor: Steven Benjamin Beckman, Boulder, CO (US)

(21) Appl. No.: 16/571,980

(22) Filed: Sep. 16, 2019

Related U.S. Application Data
(60) Provisional application No. 62/731,361, filed on Sep. 14, 2018.

(51) Int. Cl. A42B 3/06; A63B 71/10; A42B 3/12

(52) U.S. Cl. CPC A42B 3/069; A63B 71/10; B29L 2031/4821; A42B 3/063; A42B 3/125

(57) ABSTRACT

A complete helmet assembly comprising an inner helmet assembly similar to a baseball, softball, or cricket helmet and an exterior shell assembly are disclosed. The inner helmet assembly is similar to a standard helmet. The exterior shell assembly comprises two or more layers, one of said layers (preferably the more exterior layer) being hard and elastic and one or more of said layers (preferably a more internal layer) being a plastically deformable layer comprising a crumple zone that would need to be replaced after the exterior shell assembly receives significant damage. The user gets the advantages of both a reusable interior helmet and the advantages of single impact safety materials commonly used in bicycle and motorcycle helmets.

### CROSS REFERENCE TO RELATED APPLICATIONS

This application claims the benefit of U.S. Provisional Patent Application No. 62/731,361, filed on Sep. 14, 2018, and also titled “Baseball Helmet and Related Methods” which is incorporated by reference herein in its entirety for all purposes.

### BACKGROUND OF THE INVENTION

### 1. Field of the Invention

This invention is related to sports equipment; specifically, embodiments of the description are related to sports helmets.

### 2. Description of Related Art

There are many helmets used for safety while riding, such as: bicycle, motorsport, and equestrian helmets that incorporate deforming non-rebounding materials because such materials have superior energy absorption characteristics versus non-deforming rebound materials. These riding helmets all share something in common, which is that the integrity of the capacity of the helmet to absorb impact deteriorates dramatically after one impact and it is recommended by the manufacturer that the entire helmet be replaced after each impact. In other words, if you fall off your bike and hit your head, the ability of the helmet to protect the user has been compromised for further use by that single impact.

Currently, no hard-projectile sports helmets, such as: baseball, softball, or cricket helmets incorporate the deforming non-rebounding material used in riding helmets. This is because hard-projectile sports helmets are designed to be used through multiple impacts without replacing the helmet or delaying the game. All hard-projectile sport helmets are designed for durability, and while this provides cost and convenience advantages, it doesn't provide the maximum single strike energy absorption user protection and safety offered by the deforming non-rebounding material used in riding helmets.

The design described below allows users of helmets designed for sports where the emphasis is protecting the user from hard projectiles to have the safety of the deforming non-rebounding crumple material of riding helmets and the durability of traditional sporting helmets by merging a removable and replaceable shell of non-rebounding crumple material over a traditional helmet shell into a single unified helmet design. Currently, there are no helmets that have two detachable shells incorporated into its form, whereby one shell houses a deformable non-rebounding impact absorption material. The two-shell design comprises an inner traditional helmet with a hardened shell, and a second outer shell that houses deforming non-rebounding crumple material. The second shell (outermost shell) is designed to flex and rebound upon impact allowing force dispersion from the flexible outer shell itself into the sandwiched non-rebounding crumple material between the inner and outer shell. This two-shell design, with a hardened inner shell and a flexible outer shell, creates a crumple zone, which is composed of the non-rebounding deformation material between the two. Once the exterior shell has received a single impact; for example, by a pitched baseball; you can simply remove it from the inner shell and replace it restoring the full energy absorbing protective ability of the helmet.

### SUMMARY OF THE INVENTION

A complete helmet assembly comprising an inner helmet assembly and an exterior shell assembly is disclosed which would be ideal for baseball, softball, and cricket helmets. The inner helmet assembly is similar to a standard helmet. The exterior shell assembly comprises two or more layers; one of said layers (preferably the more exterior layer) being hard and elastic and one or more of said layers (preferably a more internal layer) being a plastically deformable layer comprising a crumple zone that would need to be replaced after the exterior shell assembly receives impact. The user gets the energy absorbing advantages of both a reusable interior helmet and the advantages of single impact safety materials commonly used in bicycle and motorcycle helmets.

### BRIEF DESCRIPTION ON THE DRAWINGS

Various embodiments are described herein with reference to the following Drawings Certain aspects of the Drawings are depicted in a simplified way for reason of clarity. Not all alternatives and options are shown in the Drawings and, therefore, the Claims are not limited in scope to the content of the Drawings.

### 1. FIGURES

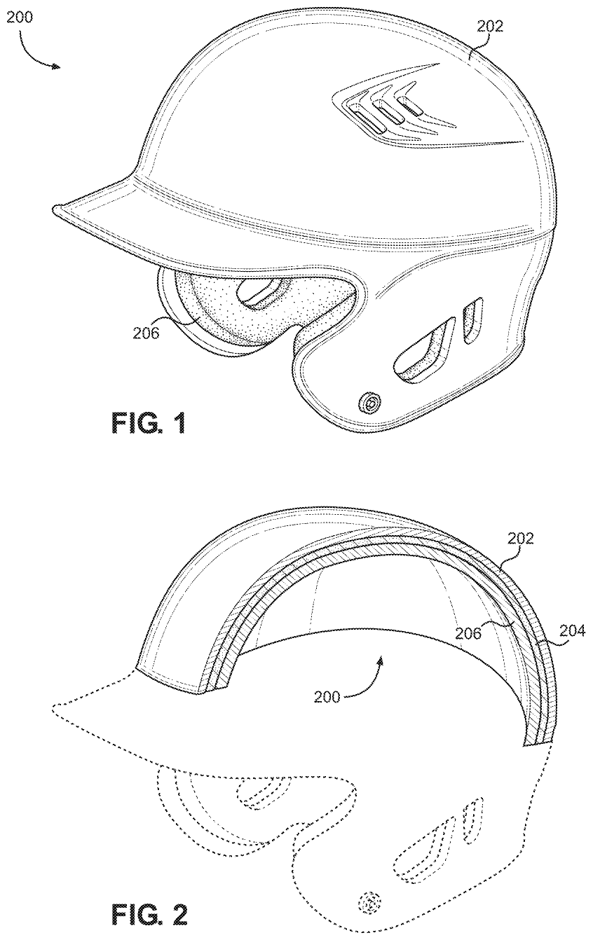

FIG. 1 is a perspective view of a currently available baseball helmet;

FIG. 2 is a side view of a cross-section of a portion of the helmet illustrated in FIG. 1;

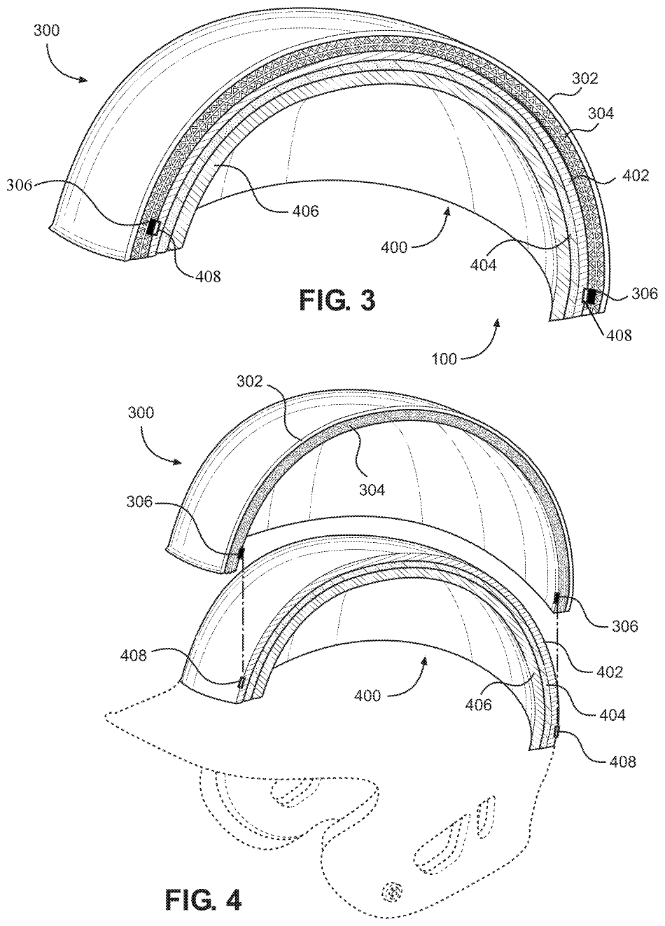

FIG. 3 is a side view of a cross-section of a complete helmet assembly, in one embodiment of the invention; and

FIG. 4 is an exploded side view of a cross-section of a portion of an inner helmet assembly uncoupled from an exterior helmet assembly, in one embodiment of the invention.

Corresponding reference characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiment are often not depicted in order to facilitate a less obstructed view of these various embodiments of the present disclosure.

### 2. REFERENCES

100 Complete Helmet Assembly
200 Common Helmet
202 Hard Outer Shell of Common Helmet
204 First Foam Layer for Protection of Common Helmet
206 Second Foam Layer for Comfort of Common Helmet
300 Exterior Shell Assembly
302 Hard Outer Shell of Exterior Shell Assembly
304 Plastically Deformable Foam Layer of Exterior Shell Assembly
306 Exterior Shell Assembly Coupling Mechanism
400 Interior Shell Assembly
402 Hard Outer Shell of Interior Shell Assembly
404 First Foam Layer for Protection of Interior Shell Assembly
406 Second Foam Layer for Comfort of Interior Shell Assembly
408 Inner Shell Assembly Coupling Mechanism

### DETAILED DESCRIPTION

The following description is not to be taken in a limiting sense but is made merely for the purpose of describing the general principles of exemplary embodiments, many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

Unless otherwise indicated, the drawings are intended to be read (e.g., arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightward”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

For the purposes of promoting an understanding of the principles of the present invention, reference will now be made to the embodiments illustrated in the drawings and specific language will be used to describe the same.

Turning now to FIG. 1 and FIG. 2, shown is a perspective and side cross-section view of a helmet 200 known to be currently available. Typically, the helmet 200 will include a hard-outer shell 202 that may be made of a plastic such as an acrylonitrile butadiene styrene (ABS) polymer, to absorb some of the shock and/or deflect a baseball striking the helmet 200. The shell 202 may be reinforced with carbon fiber and/or Kevlar.

The interior of the shell 202, closer to the user's head, typically comprises a first foam layer 204, such as a layer of polyethylene or other similar thermoplastic polymer resin. The first foam layer 204 provides a cushioning effect for the user and absorbs some impact. The first foam layer 204 is typically elastic.

Interior from the first foam layer 204, is typically a second foam layer 206, which may be a highly elastic layer such as a thermoplastic like ethylene vinyl acetate (EVA). Said second foam layer 206 is provided for the comfort of the user; for example, by improving fit and/or keeping the head cool.

Other layers that are not shown may be provided. For example, interior leather layers may be provided around the sweat areas for comfort, and/or a thin elastic padding such as a thin layer of expanded polyethylene (EPE) may be provided between the shell 202 and first foam layer 204 to protect the head from the shell 202 at certain pressure points.

Turning now to FIGS. 3 and 4, a complete helmet assembly 100 is now described. Said complete helmet assembly may comprise one or more exterior shell assemblies 300 and an inner helmet assembly 400.

An inner helmet assembly 400, as seen clearly in FIG. 4, may include a hard shell layer 402 that is substantially similar to the outer shell 202 of the common helmet 200 shown in FIGS. 1 and 2. The hard shell layer 402 may be made of a plastics such as an acrylonitrile butadiene styrene (ABS) polymer, to absorb some of the shock and/or deflect a baseball striking the helmet. The hard shell 402 may be reinforced with one or more of: plastics, polycarbonate, fiberglass, carbon fiber, Kevlar, and/or additional materials suitable to their purpose.

Interior of the hard shell of the inner assembly 402 may be a first foam layer of an inner assembly 404 that is substantially similar to the foam layer 204 of a common helmet 200. The first foam layer of an inner assembly 404 may include a layer of polyethylene or other similar thermoplastic polymer resin. The first foam layer of an inner assembly 404 may provide a cushioning effect for the user and absorb some impact. The first foam layer of an inner assembly 404 is built to elastically deform.

Interior of the first foam layer of an inner assembly 404 may be a second foam layer of an inner assembly 406 that is substantially similar to second interior foam layer of a common helmet 206. The second foam layer of an inner assembly 406 may be a highly elastic thermoplastic such as ethylene vinyl acetate (EVA) or other material suitable to its purpose. The second foam layer of an inner assembly 406 may provide for the comfort of the user, for example by improving fit and/or keeping the head cool.

Other layers that are not shown may be provided in the inner helmet assembly 400. For example, interior leather layers may be provided around the sweat areas for comfort, and/or a thin elastic padding such as a thin layer of expanded polyethylene (EPE) may be provided between the shell 402 and first inner helmet foam layer 404 to protect the head from the shell 402 at certain pressure points.

As seen in FIG. 4, the exterior shell assembly 300 may comprise an outer elastic shell 302. The outer elastic shell 302 may be made of one or more materials such as: plastics, plastic derivatives, metals, and/or any other durable material suitable for its purpose. The outer elastic shell 302 may be configured to have ideal elastically deformity upon impact by an object travelling at variable speed ranges from 30 miles per hour to 200 miles per hour.

The exterior shell assembly 300 may include a plastically deformable foam layer 304 positioned interior of the outer elastic shell 302. The plastically deformable foam layer 304 may include EPS, melamine foam, aluminum foam, cork, balsa, wood, polyethylene, polystyrene, polymer foams, metal foams, glass foams, honeycomb design materials and/or other deformable materials that plastically deform upon impact. A method of manufacturing an exterior shell assembly such as assembly 300 may include coupling an elastic shell to a plastically deformable material. The method may be accomplished using materials previously described herein. The exterior shell assembly 300 may also comprise one or more additional outer or inner shell layers made of materials comprising either elastic or inelastic properties and made of either hard or soft materials. The exterior shell assembly may include one or more coupling mechanisms 306 which may detachably couple with one or more coupling mechanism on 408 on the inner shell assembly.

As seen in FIG. 4, the exterior shell assembly 300 may be detachably coupled to the inner helmet assembly 400 by one or more coupling mechanisms located on either the inner shell assembly 408 or the outer shell assembly 306. The coupling mechanisms may be one or more of: a snap-fit engagement, pressure fit, tie on, magnetic, an interference fit, a clip, a buckle, Velcro, screws, buttons, slides, latches, loops, non-permanently adhesive glues, pegs, an elastic band, or any other coupling mechanisms known in the art. The exterior shell coupling mechanisms 306 may be configured to couple the exterior shell assembly 300 after market to a commonly available helmet 200, such as a baseball helmet.

In use, the exterior shell assembly 300 may be uncoupled from the inner helmet assembly 400 after each hit by a ball. That is, a method of using a helmet assembly may include detaching a first exterior shell assembly such as assembly 300 from an inner helmet assembly 400, and then attaching a second exterior shell assembly such as assembly 300 to the undamaged inner helmet assembly 400.

A method of manufacturing a complete helmet assembly may comprise removably coupling an exterior shell assembly such as assembly 300 to an inner helmet assembly such as helmet assembly 400; a method of manufacture may also include removably coupling an exterior shell assembly such as assembly 300 to a standard helmet such as helmet 200.

Information as herein shown and described in detail is fully capable of attaining the above-described object of the present disclosure, the presently preferred embodiment of the present disclosure; and is, thus, representative of the subject matter; which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

What is claimed is:

1. A complete helmet assembly, comprising:
an exterior shell assembly having a plastically deformable non-rebounding crumple layer;
an inner shell assembly having an elastically deformable rebounding hard outer shell and an elastically deformable rebounding inner foam layer; and
a coupling mechanism for removably coupling the exterior shell assembly from the inner shell assembly.

2. The complete helmet assembly of claim 1, wherein said inner shell assembly is a common baseball, softball, or cricket helmet.

3. The complete helmet assembly of claim 1, wherein the exterior shell assembly comprises an elastically deformable rebounding hard outer shell layer positioned exterior of the plastically deformable non-rebounding crumple layer.

4. The complete helmet assembly of claim 3, wherein said plastically deformable non-rebounding crumple layer is foam.

5. The complete helmet assembly of claim 4, wherein said plastically deformable non-rebounding crumple layer comprises polystyrene foam.

6. The complete helmet assembly of claim 4, wherein said plastically deformable non-rebounding crumple layer comprises polyethylene foam.

7. The complete helmet assembly of claim 4, wherein said plastically deformable non-rebounding crumple layer comprises polymer foam.

8. The complete helmet assembly of claim 4, wherein said plastically deformable non-rebounding crumple layer comprises melamine foam.

9. The complete helmet assembly of claim 4, wherein said plastically deformable non-rebounding crumple layer comprises metal foams.

10. The complete helmet assembly of claim 4, wherein said plastically deformable non-rebounding crumple layer comprises glass foams.

11. The complete helmet assembly of claim 4, wherein said plastically deformable non-rebounding crumple layer comprises metal foams.

12. The complete helmet assembly of claim 1, wherein said plastically deformable non-rebounding crumple layer comprises honeycomb design materials.

13. The complete helmet assembly of claim 1, wherein said plastically deformable non-rebounding crumple layer comprises wood materials.

14. A method of assembling a complete helmet assembly, comprising:
providing an exterior shell assembly having a plastically deformable non-rebounding crumple layer;
providing an inner shell assembly having an elastically deformable rebounding hard outer shell and an elastically deformable rebounding inner layer;
providing a coupling mechanism; and
using the coupling mechanism, removably coupling the exterior shell assembly to the inner shell assembly.

15. A method of assembling a complete helmet assembly of claim 14, wherein said inner shell assembly is a common baseball, softball, or cricket helmet.

16. A method of assembling a complete helmet assembly of claim 14, wherein said exterior shell is replaced when it has been deformed or damaged.

17. A method of assembling a complete helmet assembly of claim 14, wherein said exterior shell assembly comprises an elastically deformable rebounding hard outer shell layer positioned exterior of the plastically deformable non-rebounding crumple layer.

18. A method of assembling a complete helmet assembly of claim 14, wherein said plastically deformable non-rebounding crumple layer is foam.

19. A method of assembling a complete helmet assembly of claim 18, wherein said plastically deformable non-rebounding crumple layer comprises polystyrene foam.

20. A method of assembling a complete helmet assembly of claim 18, wherein said plastically deformable non-rebounding crumple layer comprises polyethylene foam.
